(19) United States
(12) Patent Application Publication
(10) Pub. No.: US 2026/0253116 A1
(43) Pub. Date: Aug. 27, 2026

(54) INFORMATION PROCESSING APPARATUS, INFORMATION PROCESSING SYSTEM, AND INFORMATION PROCESSING METHOD

(71) Applicant: NEC Corporation, Tokyo (JP)

(72) Inventors: Ning LI, Tokyo (JP); Hiroki SUGEGAYA, Tokyo (JP); Shunsuke TSUDA, Tokyo (JP)

(73) Assignee: NEC Corporation, Tokyo (JP)

(21) Appl. No.: 19/162,422

(22) PCT Filed: Mar. 15, 2023
(86) PCT No.: PCT/JP2023/010161

§ 371 Date: Sep. 5, 2025

(51) Int. Cl. G06Q 30/0601; G06F 21/32; G06Q 20/20; G06Q 20/40

(52) U.S. Cl. CPC G06Q 30/0623; G06F 21/32; G06Q 20/208; G06Q 20/40145; G06Q 30/0639; G06Q 30/0641

(57) ABSTRACT

An information processing apparatus includes: a product information acquisition unit that acquires product information about a product; a product processing unit that processes the product by using the product information; and a change unit that changes an operation of at least one of the product information acquisition unit and the product processing unit, depending on at least one of a target who uses the information processing apparatus and a position of the information processing apparatus.

### TECHNICAL FIELD

This disclosure relates to technical fields of an information processing apparatus, an information processing system, an information processing method, and a recording medium.

### BACKGROUND ART

Patent Literature 1 describes a service provision apparatus including moving means of moving to a destination, provision means of providing a service while moving together with the moving means, and acquisition means of acquiring information at the destination where the service is provided by the provision means.

Patent Literature 2 describes a technology/technique of assisting a responder who responds to a customer, by using a customer service robot that acquires a face image of a visitor and a face image of a responder who responds to the visitor, identifies the visitor based on the face image of the visitor, acquires information associated with the identified visitor, identifies the attendant based on the face image of the attendant, determines a viewing authority of the identified responder, and instructing a terminal of the responder to display information corresponding to the determined viewing authority, the information being selected from the acquired information.

Patent Literature 3 describes a robot control apparatus that moves a robot to a stop position of a customer, based on an area and staying time recorded in a customer movement table, and causes the robot having moved to the customer to propose products based on product categories related to the area where the customer has stayed most recently. This proposal is made based on a plurality of consecutive product categories in the order of movement among the product categories in the area where the customer has stayed.

Patent Literature 4 describes a technology/technique of delivering a package to a recipient, by using an unmanned aerial vehicle that transports a package to an intermediate location on the way of delivering the package; and a self-propelled robot that delivers the package that is unloaded at the intermediate location, to the recipient's address.

### CITATION LIST

### Patent Literature

Patent Literature 1: JP2018-005650 A
Patent Literature 2: JP2018-041231 A
Patent Literature 3: JP2019-049785 A
Patent Literature 4: JP2022-073395 A

### SUMMARY

It is an example object of this disclosure to provide an information processing apparatus, an information processing system, an information processing method, and a recording medium that are intended to improve the techniques/technologies disclosed in Citation List.

### Solution to Problem

An information processing apparatus according to an example aspect includes: a product information acquisition unit that acquires product information about a product; a product processing unit that processes the product by using the product information; and a change unit that changes an operation of at least one of the product information acquisition unit and the product processing unit, depending on at least one of a target who uses the information processing apparatus and a position of the information processing apparatus.

An information processing system according to an example aspect includes: a plurality of payment support apparatuses; and a shared apparatus, each of the plurality of payment support apparatuses including: a product information acquisition unit that acquires product information indicating a product; a product processing unit that processes the product by using the product information; a change unit that changes an operation of at least one of the product information acquisition unit and the product processing unit, depending on at least one of a target who uses the payment support apparatus and a position of the payment support apparatus; and a payment communication unit that communicates with an external apparatus of the payment support apparatus, the shared apparatus including: a shared communication unit that communicates with an external apparatus of the shared apparatus; and a recording unit that acquires, from each of the plurality of payment support apparatuses via the payment communication unit and the shared communication unit, payment support apparatus information including at least one of position information indicating a position of the payment support apparatus, usage status information indicating a usage status of the payment support apparatus, and payment information indicating payment made at the payment support apparatus, the recording unit recording the payment support apparatus information.

An information processing method according to an example aspect includes: acquiring product information about a product, by using a product information acquisition unit that provided in an information processing apparatus; processing the product by using the product information, by using a product processing unit that provided in the information processing apparatus; and changing an operation of at least one of the product information acquisition unit and the product processing unit, depending on at least one of a target who uses the information processing apparatus and a position of the information processing apparatus.

A recording medium according to an example aspect is a recording medium on which a computer program that allows a computer to execute an information processing method is recorded, the information processing method including: acquiring product information about a product, by using a product information acquisition unit that provided in an information processing apparatus; processing the product by using the product information, by using a product processing unit that provided in the information processing apparatus; and changing an operation of at least one of the product information acquisition unit and the product processing unit, depending on at least one of a target who uses the information processing apparatus and a position of the information processing apparatus.

### BRIEF DESCRIPTION OF DRAWINGS

FIG. 1 is a block diagram illustrating a configuration of an information processing apparatus in a first example embodiment.

FIG. 2 is an external appearance view illustrating the external appearance of a register robot in a second example embodiment.

FIG. 3 is a block diagram illustrating a configuration of the register robot in the second example embodiment.

FIG. 4 is a flowchart illustrating a flow of an information processing operation of the register robot in the second example embodiment.

FIG. 5 is a conceptual diagram illustrating an example of product information acquired by the register robot in the second example embodiment.

FIG. 6 is a block diagram illustrating a configuration of a register robot in a third example embodiment.

FIG. 7 is a flowchart illustrating a flow of the information processing operation of the register robot in the third example embodiment.

FIG. 8 is a block diagram illustrating a configuration of a register robot in a fourth example embodiment.

FIG. 9 is a flowchart illustrating a flow of the information processing operation of the register robot in the fourth example embodiment.

FIG. 10 is a block diagram illustrating a configuration of an information processing system in a fifth example embodiment.

FIG. 11 is a block diagram illustrating a configuration of a register robot in a sixth example embodiment.

FIG. 12 is a block diagram illustrating a configuration of a register robot in a seventh example embodiment.

FIG. 13 is a flowchart illustrating a flow of the information processing operation of the register robot in the seventh example embodiment.

FIG. 14 is a block diagram illustrating a configuration of a register robot in an eighth example embodiment.

FIG. 15 is a flowchart illustrating a flow of the information processing operation of the register robot in the eighth example embodiment.

### DESCRIPTION OF EXAMPLE EMBODIMENTS

Hereinafter, with reference to the drawings, an information processing apparatus, an information processing system, an information processing method, and a recording medium according to example embodiments will be described.

### 1: First Example Embodiment

An information processing apparatus, an information processing system, an information processing method, and a recording medium according to a first example embodiment will be described. The following describes the information processing apparatus, the information processing system, the information processing method, and the recording medium according to the first example embodiment, by using an information processing apparatus 1 to which the following describes the information processing apparatus, the information processing system, the information processing method, and the recording medium according to the first example embodiment are applied.

### [1-1: Configuration of Information Processing Apparatus 1]

FIG. 1 is a block diagram illustrating a configuration of the information processing apparatus 1 in the first example embodiment. As illustrated in FIG. 1, the information processing apparatus 1 is provided with a product information acquisition unit 11, a product processing unit 12, and a store change unit 13. The product information acquisition unit 11 acquires product information about a product or an item. The product processing unit 12 processes a product by using the product information. The store change unit 13 changes an operation of at least one of the product information acquisition unit 11 and the product processing unit 12, depending on at least one of a person who uses the information processing apparatus 1 and a position of the information processing apparatus 1.

### [1-2: Technical Effect of Information Processing Apparatus 1]

The information processing apparatus 1 in the first example embodiment is allowed to appropriately change the operation of at least one of acquiring the product information and processing the product, depending on a usage status of the information processing apparatus 1.

### 2: Second Example Embodiment

Next, an information processing apparatus, an information processing system, an information processing method, and a recording medium according to a second example embodiment will be described. The following describes the information processing apparatus, the information processing system, the information processing method, and the recording medium according to the second example embodiment, by using an information processing apparatus to which the following describes the information processing apparatus, the information processing system, the information processing method, and the recording medium according to the second example embodiment are applied.

[2-1: Example of Scene where Register Robot 2 is Applied]

Hereinafter, the information processing apparatus to which the second example embodiment is applied will be referred to as a register robot 2. The register robot 2 supports the sales of products handled by stores. The register robot 2 operates in an area in which a plurality of stores are open. The register robot 2 may function as a register for the plurality of stores. The register robot 2 functions as a register for any one of the plurality of stores, as appropriate.

### [2-2: External Appearance of Register Robot 2]

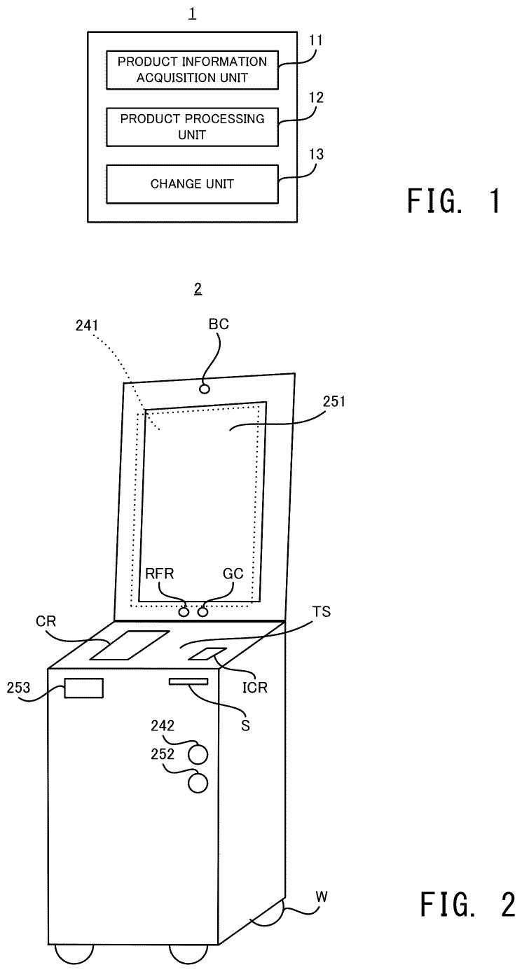

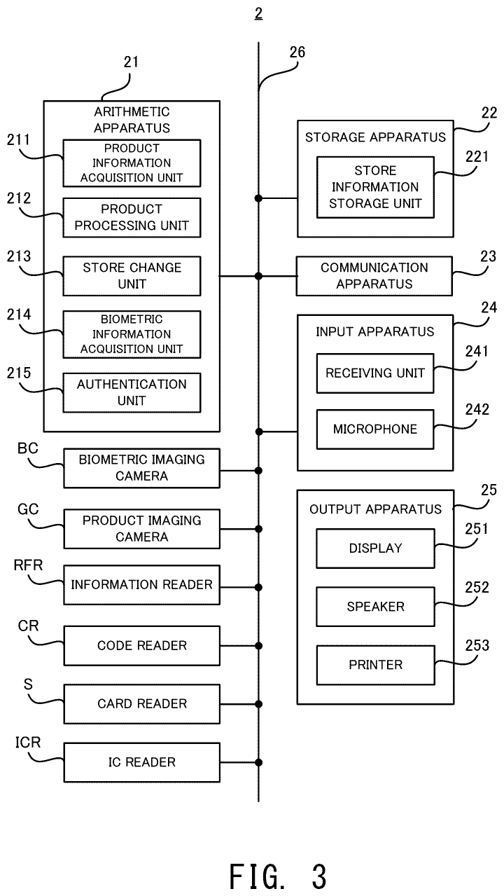

FIG. 2 is an external appearance view illustrating the external appearance of the register robot 2. As illustrated in FIG. 2, the register robot 2 may be provided with, for example, a biometric imaging camera BC, a product imaging camera GC, an information reader RFR, a code reader CR, a display 251, a receiving unit 241, a microphone 242, a speaker 252, a printer 253, a card reader S, and an IC reader ICR.

The biometric imaging camera BC captures images of a target. The biometric imaging camera BC may be provided at a position that facilitates the image capture of a face of the target. The product imaging camera GC captures images of a product. The product imaging camera GC may be provided at a position that facilitates the image capture of a product placed on a top surface TS of the register robot 2. The biometric imaging camera BC and the product imaging camera GC may be integrated, and the image capture of the target and the image capture of the product may be realized by a single camera with a wide field of view.

The information reader RFR reads information from an object/item attached to the product. The object/item attached to the product may be a tag, for example. The information read by the information reader RF may be the product information or identification information for identifying the product. The information reader RFR may be provided at a position that facilitates the acquisition of the information from the product placed on the top surface TS of the register robot 2.

The code reader CR reads a code attached to the product. The code may be a code obtained by encoding the product information. Alternatively, the code may be a code obtained by encoding information to be used when referring to a product table described later. In this case, the product information may be acquired with reference to the product table. The code read by the code reader CR may include a two-dimensional code, a bar code, or the like. The code reader CR may be provided at a position that facilitates the reading of the code attached to the product placed on the top surface TS of the register robot 2.

The display 251 may be provided such that a purchaser can see display contents. The display 251 may, for example, present information that assists the purchaser in operating the register robot 2.

The receiving unit 241 may detect an instruction action of the purchaser in a space between the display 251 and the purchaser, thereby receiving an input. The receiving unit 241 may enable an order receiving operation such that such that the purchaser operates a touch panel without touching the display 251. On the other hand, the receiving unit 241 may be a mechanism that receives an input by being touched, such as a touch panel.

The microphone 242 inputs voice uttered by the purchaser. The microphone 242 may collect the voice with directionality. The microphone 242 may collect the voice so as not to pick up sound/voice from anyone other than the purchaser. Alternatively, the microphone 242 may input voice uttered other than by people other than the purchaser, noise, or the like, in addition to the voice uttered by the purchaser.

The speaker 252 outputs sound toward the purchaser. The speaker 252 may output the sound with directionality. The speaker 252 may output the sound such that information intended for the purchaser is not audible to anyone other than the purchaser.

The printer 253 may output paper media such as receipts and coupons to be provided to the purchaser.

The card reader S reads a credit card. The IC reader ICR reads an IC card used as electronic money. A shape of the register robot 2, the arrangement of each device, and the like are merely examples, and any shape and arrangement may be adopted.

### [2-3: Configuration of Register Robot 2]

FIG. 3 is a block diagram illustrating a configuration of the register robot 2 in the second example embodiment. As illustrated in FIG. 3, the register robot 2 is provided with an arithmetic apparatus 21 and a storage apparatus 22. Furthermore, the register robot 2 may be provided with a communication apparatus 23, an input apparatus 24, and an output apparatus 25. The register robot 2, however, may not be provided with at least one of the communication apparatus 23, the input apparatus 24, and the output apparatus 25. The arithmetic apparatus 21, the storage apparatus 22, the communication apparatus 23, the input apparatus 24, and the output apparatus 25 may be connected via a data bus 26.

The arithmetic apparatus 21 includes, for example, at least one of a CPU (Central Processing Unit), a GPU (Graphics Processing Unit), and an FPGA (Field Programmable Gate Array). The arithmetic apparatus 21 reads a computer program. For example, the arithmetic apparatus 21 may read a computer program stored in the storage apparatus 22. For example, the arithmetic apparatus 21 may read a computer program stored in a computer-readable and non-transitory recording medium, by using a not-illustrated recording medium reading apparatus provided in the register robot 2 (e.g., the input apparatus 24 described later). The arithmetic apparatus 21 may acquire (i.e., download or read) a computer program from a not-illustrated apparatus disposed outside the register robot 2, via the communication apparatus 23 (or another communication apparatus). The arithmetic apparatus 21 executes the read computer program. Consequently, a logical function block for performing an operation to be performed the register robot 2 is realized in the arithmetic apparatus 21. That is, the arithmetic apparatus 21 is allowed to function as a controller for realizing the logical function block f for performing an operation (in other words, processing) to be performed by the register robot 2.

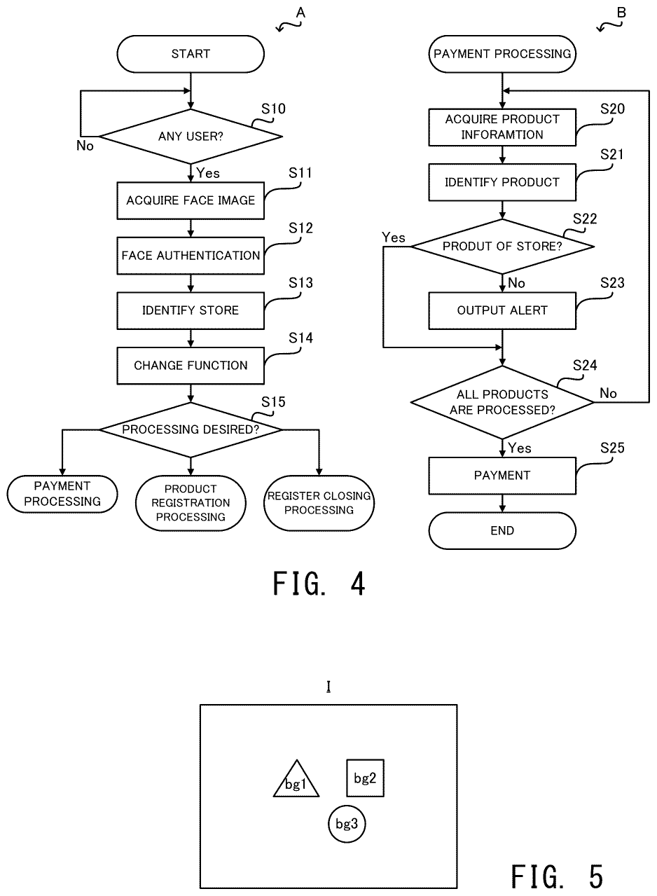

FIG. 3 illustrates an example of the logical function block realized in the arithmetic apparatus 21 in order to perform an information processing operation. As illustrated in FIG. 3, a product information acquisition unit 211 that is a specific example of the “product information acquisition unit” described in Supplementary Notes later, a product processing unit 212 that is a specific example of the “product processing unit” described in Supplementary Notes later, a store change unit 213 that is a specific example of the “change unit” described in Supplementary Notes later, a biometric information acquisition unit 214 that is a specific example of the “biometric information acquisition unit” described in Supplementary Notes later, and an authentication unit 215 that is a specific example of the “authentication unit” described in Supplementary Notes later, are realized in the arithmetic apparatus 21. However, any one of the biometric information acquisition unit 214 and the authentication unit 215 may not be realized in the arithmetic apparatus 21. The details of operation of the product information acquisition unit 211, the product processing unit 212, the store change unit 213, the biometric information acquisition unit 214, and the authentication unit 215 will be described later with reference to FIG. 4.

The storage apparatus 22 is configured to store desired data. For example, the storage apparatus 22 may temporarily store a computer program to be executed by the arithmetic apparatus 21. The storage apparatus 22 may temporarily store data that are temporarily used by the arithmetic apparatus 21 when the arithmetic apparatus 21 executes the computer program. The storage apparatus 22 may store data that are stored for a long time by the register robot 2. The storage apparatus 22 may include at least one of a RAM (Random Access Memory), a ROM (Read Only Memory), a hard disk apparatus, a magneto-optical disk apparatus, a SSD (Solid State Drive), and a disk array apparatus. That is, the storage apparatus 22 may include a non-transitory recording medium.

The communication apparatus 23 is configured to communicate with an apparatus external to the register robot 2 via a not-illustrated communication network. The communication apparatus 23 may be a communication interface based on standards such as Ethernet (registered trademark), Wi-Fi (registered trademark), Bluetooth (registered trademark), and USB (Universal Serial Bus).

The register robot 2 may not be provided with at least one of the biometric imaging camera BC, the product imaging camera GC, the information reader RFR, the code reader CR, the card reader S, and the IC reader ICR described above. In this case, at least one of the biometric imaging camera BC, the product imaging camera GC, the information reader RFR, the code reader CR, the card reader S, and the IC reader ICR may transmit information to and receive information from the register robot 2 via the communication apparatus 23.

The input apparatus 24 is an apparatus that receives an input of information to the register robot 2 from an outside of the register robot 2. For example, the input apparatus 24 may include an operating apparatus (e.g., at least one of a keyboard, a mouse, and a touch panel) that is operable by an operator of the register robot 2. For example, the input apparatus 24 may include a reading apparatus that is configured to read information recorded as data on a recording medium that is externally attachable to the register robot 2. In the second example embodiment, the register robot 2 includes the receiving unit 241 and the microphone 242

The output apparatus 25 is an apparatus that outputs information to the outside of the register robot 2. For example, the output apparatus 25 may output information as an image. That is, the output apparatus 25 may include a display apparatus (a so-called display) that is configured to display an image indicating information that is desirably outputted. For example, the output apparatus 25 may output information as audio/sound. That is, the output apparatus 25 may include an audio apparatus (a so-called speaker) that is configured to output audio/sound. Furthermore, for example, the output apparatus 25 may output information onto a paper surface. That is, the output apparatus 25 may include a printing apparatus (i.e., a printer) that is configured to print desired information on the paper surface. In the second example embodiment, the register robot 2 may include the display 251, the speaker 252, and the printer 253, as the output apparatus 25.

### [2-3: Information Processing Operation Performed by Register Robot 2]

With reference to FIG. 4, a flow of an information processing operation performed by the register robot 2 will be described. FIG. 4 includes a flowchart A illustrating a store change operation performed by the register robot 2, and FIG. 4 includes a flowchart B illustrating a payment operation performed by the register robot 2.

### [Store Change Operation]

As the flowchart A illustrated in FIG. 4, the store change unit 213 determines whether or not there is a target who uses the register robot 2 (step S10). The store change unit 213 may determine that there is a target who uses the register robot 2, for example, in a case where the receiving unit 241 detects an action (e.g., a touch action) of the target. The target may be a store clerk of any store.

When there is a store clerk who uses the register robot 2 (step S10: Yes), the biometric information acquisition unit 214 acquires biometric information on the store clerk (step S11). The biometric information acquisition unit 214 may acquire a face image of the store clerk, as the biometric information. The biometric information acquisition unit 214 may cause the biometric imaging camera BC to capture an image of the face of the target, thereby acquiring the face image of the store clerk from the biometric imaging camera BC. The biometric information may be face information including a face image, iris information including an iris image, fingerprint information including a fingerprint image, and the like.

The authentication unit 215 authenticates the store clerk by using the biometric information (step S12). The authentication unit 215 may match the biometric information on the store clerk to the biometric information registered in advance. Alternatively, the register robot 2 may transmit the acquired biometric information to an external apparatus of the register robot 2, such as a cloud server having an authentication mechanism, and may receive a result of authentication performed at the external apparatus, thereby authenticating the store clerk.

### [Store Information Storage Unit 221]

A store information storage unit 221 may be realized in the storage apparatus 22. The store information storage unit 221 may include a store clerk table, a product table, a processing table, and a payment amount table. The biometric information may be registered in the store clerk table included in the store information storage unit 221. The product table, the processing table, and the payment amount table will be described later.

In the store clerk table, information about a store clerk who works at a store may be registered for each store. The store clerk who works at a store may be referred to as a store clerk who belongs to the store. In the store clerk table, information about a store clerk who may use the register robot 2, may be registered. In the store clerk table, information about a store clerk who works for a limited period, such as a store clerk who works only for one day, may be registered.

TABLE 1
Store Clerk Table

| | STORE CLERK | |
|---|---|---|
| | IDENTIFICATION | BIOMETRIC |
| STORE | INFORMATION | INFORMATION |
| A | a1 | a1B |
| A | a2 | a2B |
| A | a3 | a3B |
| B | a1 | b1B |

. . .

As illustrated in Table 1 above, in the store clerk table, identification information for identifying the store clerk who belongs to the store and the biometric information on the store clerk, may be registered for each store. The above Table 1 illustrates, for example, that a store clerk identified by “a1,” a store clerk identified by “a2,” and a store clerk identified by “a3” belong to a store A. It also illustrates that a store clerk identified by “b1” belongs to a store B. The above Table 1 also illustrates that the biometric information on the store clerk identified by “a1” is “a1B,” the biometric information on the store clerk identified by “a2” is “a2B,” the biometric information on the store clerk identified by “a3” is “a3B,” and the biometric information on the store clerk identified by “b1” is “b1B.”

The store change unit 213 determines at which store the register robot 2 is used, based on the authentication result from the authentication unit 215 (step S13). The store change unit 213 may identify a store at which the store clerk identified by using the biometric information works, with reference to the store clerk table. The store change unit 213 determines at which store the register robot 2 is used.

The processing performed by using the register robot 2 is different for each store. The store change unit 213 changes a function of at least one of the product information acquisition unit 211 and the product processing unit 212, depending on the identified store (step S14). In the present example embodiment, the store change unit 213 changes the function to a function corresponding to the store at which the clerk works.

That is, in a case where the store clerk who belongs to the store A is authenticated, the store change unit 213 changes the function of at least one of the product information acquisition unit 211 and the product processing unit 212 so as to perform an operation related to the store A. In a case where the store clerk who belongs to the store B is authenticated, the store change unit 213 changes the function of at least one of the product information acquisition unit 211 and the product processing unit 212 so as to perform an operation related to the store B.

### [Product Information Acquisition Unit 211]

The product information acquisition unit 211 acquires the product information about the product. The product information may include information indicating a type of the product and a price of the product. The product information acquisition unit 211 may acquire the product information from a device including at least one of the product imaging camera GC serving as an imaging device, the code reader CR serving as a code reader, the information reader RFR serving as an information reader, and the receiving unit 241.

From which of the product imaging camera GC, the information reader RFR, the code reader CR, and the receiving unit 241, the product information acquisition unit 211 acquires the product information, may be changed depending on the store. The store change unit 213 identifies the store to which the target of the register robot 2 belongs, and may change from which of the product imaging camera GC, the information reader RFR, the code reader CR, and the receiving unit 241, the product information acquisition unit 211 acquires the product information.

Alternatively, the product information acquisition unit 211 may acquire information about the product information, from a device including at least one of the product imaging camera GC, the information reader RFR, the code reader CR, and the receiving unit 241. The information about the product information may include information indicating the type of the product. The product information acquisition unit 211 may acquire the product information by using the information about the product information and by referring to the product table. That is, the product information acquisition unit 211 may acquire access information for referring to the product table, instead of the product information from the device including at least one of the product imaging camera GC, the code reader CR, the information reader RFR, and the receiving unit 241.

In the product table, product information about the product that belongs to the store, is registered. Processing registering the product information in the product table by the store clerk who belongs to the store, may be referred to as product registration processing. The registration of the product information in the product table may be performed by an input action by a store clerk who is permitted to perform the product registration processing. The product information acquisition unit 211 may refer to the product table, may perform matching to products handled by the store, and may identify the product.

TABLE 2
Example 1 of Product Table

| | PRODUCT TYPE | |
|---|---|---|
| | IDENTIFICATION | |
| STORE | INFORMATION | PRICE |
| A | AG1 | ¥1,000 |
| A | AG2 | ¥500 |
| A | AG3 | ¥2,000 |

. . .

As illustrated in Table 2 above, in the product table, the product information about the product that belongs to the store may be registered for each store. As illustrated in the above Table 2, the product information may include identification information for identifying the type of the product and the price of the product. The price of the product registered in the product table may be a price without a discount, or the like.

The above Table 2 illustrates that a product of a type identified by “AG1,” a product of a type identified by “AG2,” and a product of a type identified by “AG3” belong to the store A. Furthermore, the above Table 2 illustrates that the price of the product of the type identified by “AG1” is “1,000 yen,” the price of the product of the type identified by “AG2” is “500 yen,” and the price of the product of the type identified by “AG3” is “2,000 yen.”

In a case where the product requires age verification at the time of sale, the product table may include information indicating that age verification is required. The product processing unit 212 may support an age verification operation such as displaying a confirmation screen when the product requires age verification.

In a case where the product information acquisition unit 211 acquires the product information from the code reader CR, the code reader CR reads the code attached to the product, and the product information acquisition unit 211 acquires the code. The code may be a code obtained by encoding the product information itself. The code may also be access information on access to the product table. The code that is the access information code may, for example, be a code obtained by encoding the identification information for identifying the type of the product.

In a case where the product information acquisition unit 211 acquires the product information from the receiving unit 241, the receiving unit 241 may function as a receiving device that detects an instruction action of the store clerk and receives an input corresponding to the product. In this case, the product information acquisition unit 211 may acquire the product information based on the input action performed by the store clerk on the receiving unit 241. The product information acquisition unit 211 may receive the input action corresponding to the product identified by the store clerk, thereby acquiring the product information.

In a case where the product information acquisition unit 211 acquires the information about the product information from the product imaging camera GC, an image of the product may be registered in the product table.

TABLE 3
Example 2 of Product Table

| | PRODUCT TYPE | | |
|---|---|---|---|
| | IDENTIFICATION | | |
| STORE | INFORMATION | PRICE | IMAGE |
| B | BG1 | ¥500 | bg1 |
| B | BG2 | ¥2,000 | bg2 |
| B | BG3 | ¥1,000 | bg3 |

. . .

As illustrated in Table 3 above, in the product table, the identification information for identifying the type of the product that belongs to the store, the price of the product, and the image of the product, may be registered for each store. The above Table 3 illustrates that a product of a type identified by “BG1,” a product of a type identified by “BG2,” and a product of a type identified by “BG3” belong to the store B. Furthermore, the above Table 3 illustrates that the image of the product of the type identified by “BG1” is “bg1,” the image of the product of the type identified by “BG2” is “bg2,” and the image of the product of the type identified by “BG 3” is “bg3.”

In a case where the product information acquisition unit 211 acquires the product information from the product imaging camera GC, the product information acquisition unit 211 may identify the product by image recognition, thereby acquiring the product information. The product information acquisition unit 211 identifies the product, based on the image captured by the product imaging camera GC, thereby acquiring the product information. The product information acquisition unit 211 may identify the product by matching the image captured by the product imaging camera GC to the image of the product registered in the product table, thereby acquiring the product information.

For example, let us assume that the product imaging camera GC captures an image I illustrated in FIG. 5. The image I illustrated in FIG. 5 includes the image “bg1,” the image “bg2,” and the image “bg3.” The product information acquisition unit 211 may acquire the product information about the product of the type identified by “BG1” corresponding to the image “bg1,” the product of the type identified by “BG2” corresponding to the image “bg2,” and the product of the type identified by “BG 3” corresponding to image “bg3.”

For example, at a store at which products that cannot include information such as unpackaged fruits and other foods, are handled, processing using the product imaging camera GC or the receiving unit 241 may be performed.

In a case where the product information acquisition unit 211 acquires the product information from the information reader RFR, the product information may include information about the corresponding product registered in the product table. That is, the product information acquisition unit 211 may acquire information included in the product table, such as the store to which the product belongs, the type of the product, and the price, without referring to the product table.

### [Product Processing Unit 212]

The product processing unit 212 processes the product by using the product information. The store change unit 213 changes the function of the product processing unit 212, depending on the store at which the store clerk works. The processing of the product by the product processing unit 212 is different for each store. The processing of the product by the product processing unit 212 may be registered in the processing table.

TABLE 4
Processing Table

| | STORE | STORE | STORE |
|---|---|---|---|
| STORE | PROCESSING | PROCESSING | PROCESSING |
| A | STORE A | STORE A | STORE A |
| | PROCESSING 1 | PROCESSING 2 | PROCESSING 3 |
| B | STORE B | STORE B | STORE B |
| | PROCESSING 1 | PROCESSING 2 | PROCESSING 3 |

. . .

As illustrated in Table 4 above, in the processing table, the processing to be performed at the store may be registered for each store. The above Table 4 illustrates that “store A processing 1,” “store A processing 2,” and “store A processing 3” are performed at the store A. It also illustrates that “store B processing 1,” “store B processing 2,” and “store B processing 3” are performed at the store B. For example, the “store A processing 1” may be payment/settlement processing. The “store A processing 2” may be the product registration processing. The “store A processing 3” may be register closing processing.

The payment processing may include processing related to point cards. In a case where the store awards points based on a payment amount, the store may accept payments using the points.

In addition, the payment processing may include discount processing, issuing tickets or receipts from the printer 253, and the like.

The product registration processing may include product disposal processing, product delivery processing, and the like. The register closing processing may include stopping the payment processing, registering cash in the store's account, and the like. The register closing processing may include processing related to point cards.

In addition, the processing that may be performed by the product processing unit 212 may include electronic money charging processing, displaying the above-mentioned processing on the display 251, output processing, such as outputting the sound from the speaker 252, adult verification processing, etc.

The product processing unit 212 determines the processing desired by the store clerk who belongs to the store (step S15). In a case where the store clerk belongs to the store A, the product processing unit 212 determines which of the payment processing, the product registration processing, and the closing processing, the processing desired by the store clerk is. The product processing unit 212 may control the receiving unit 241 and the display 251 to provide a user interface appropriate for the store.

In addition, in the present example embodiment, the store change unit 213 may restrict the processing that may be performed, only to the processing that the store clerk is permitted to perform. The store clerk table may include information about the processing that the store clerk is permitted to perform.

TABLE 5
Store Clerk Table

| | STORE CLERK | | STORE | STORE | STORE |
|---|---|---|---|---|---|
| | IDENTIFICATION | BIOMETRIC | PROCESSING | PROCESSING | PROCESSING |
| STORE | INFORMATION | INFORMATION | A1 | A2 | A3 |
| A | a1 | a1B | PERMITTED | PERMITTED | PERMITTED |
| A | a2 | a2B | PERMITTED | PERMITTED | NOT |
| | | | | | PERMITTED |
| A | a3 | a3B | PERMITTED | NOT | NOT |
| | | | | PERMITTED | PERMITTED |

. . .

As illustrated in Table 5 above, in the store clerk table, the identification information for identifying the store clerk who belongs to the store, the biometric information on the store clerk, and information indicating whether or not each processing is permitted, may be registered for each store. The above Table 5 illustrates that the store clerk identified by “a1” is permitted to perform all of the store A processing 1, the store A processing 2, and the store A processing 3, that the store clerk identified by “a2” is permitted to perform the store A processing 1 and the store A processing 2, but not the store A processing 3, and that the store clerk identified by “a3” is permitted to perform the store A processing 1, but not the store A processing 2 and the store A processing 3. The registration of the store clerk in this store clerk table may be performed by the operation of the product processing unit 212.

The product processing unit 212 may control the display 251 to display only an operation screen for the processing that the store clerk is permitted to perform. The product processing unit 212 may control the receiving unit 241 and the display 251 to provide a user interface appropriate for the store clerk. This improves convenience for the store clerk.

### [Payment Processing]

As the flowchart B illustrated in FIG. 4, the product information acquisition unit 211 acquires the product information (step S20). The output apparatus 25 may notify the target which method is used to acquire the product information at the store. The action by the target may be prompted by the notification.

For example, in a case where a product code is identified from the image of the product itself, information such as “Please place the product in the predetermined location” may be outputted from the output apparatus 25 such as a display and a speaker, and the target may be prompted to place the product in an imaging range of the product imaging camera GC.

The product information acquisition unit 211 identifies the product indicated by the product information (step S21). The product information acquisition unit 211 determines whether or not the product belongs to the store at which the register robot 2 is used (step S22). The product information acquisition unit 211 may refer to the product table to determine whether or not the product belongs to the store. When the product does not belong to a store at which the register robot 2 is used (step S22: No), an alert notification indicating that the product does not belong to the store is outputted (step S23). The alert notification is outputted even in a case where the product information acquisition unit 211 cannot identify the product in the step S21, for example, in a case where the product is not handled by any store that is supported by the register robot 2.

When the product belongs to the store at which the register robot 2 is used (step S22: Yes), the product processing unit 212 determines whether or not all products are processed (step S24). In the step S24, the product processing unit 212 may cause the display 251 to display a list of the products that belong to the identified store and may have the store clerk confirm the list.

When an input indicating that all products are processed is received from the store clerk, the processing may proceed to step S25. The product processing unit 212 performs payment for the products (step S25). In the step S25, it is possible to select which payment method is used for the payment. The payment methods that are acceptable may be different depending on the store. For example, the store A may allow payment by electronic money, payment by credit card, or code payment. In a case where the register robot 2 is equipped with an automatic change dispenser, payment in cash may also be allowed. The product processing unit 212 may cause the display 251 to display a screen that allows the purchaser to select which payment method is used for the payment. In the operation in the step S25, the product processing unit 212 may register information about the payment in the payment amount table.

TABLE 6
Payment Amount Table

| | PRODUCT TYPE | | |
|---|---|---|---|
| | IDENTIFICATION | PAYMENT | PAYMENT |
| STORE | INFORMATION | METHOD | AMOUNT |
| A | AG1 | CREDIT CARD | ¥500 |
| | | PAYMENT | |
| A | AG2 | CREDIT CARD | ¥2,000 |
| | | PAYMENT | |
| A | AG1 | CASH PAYMENT | ¥500 |
| A | AG2 | CODE PAYMENT | ¥1,900 |
| A | AG3 | ELECTRONIC | ¥1,000 |
| | | MONEY PAYMENT | |

. . .

As illustrated in Table 6 above, in the payment amount table, the identification information on the type of the paid product, an actual payment amount, and the payment method may be registered for each store. The actual payment amount may be different from the price included in the product information. For example, in a case where a discount coupon is presented, the payment may be made based on a value adjusted by using information indicated by the coupon. The above Table 6 illustrates that at the store A, 500 yen is paid by credit card for the product of the type identified by “AG1”, 2,000 yen is paid by credit card for the product of the type identified by “AG2”, 500 yen is paid in cash for the product of the type identified by “AG1”, 1,900 yen is paid by code for the product of the type identified by “AG2”, and 1,000 yen is paid by electronic money for the product of the type identified by “AG3.”

### [2-4: Technical Effect of Register Robot 2]

The register robot 2 in the second example embodiment is configured to identify the store to which the store clerk using the register robot 2 belongs, based on the store clerk who uses the register robot 2, and it is therefore possible to appropriately change the function of at least one of acquiring the product information and processing the product, depending on the store. For example, in a case where the store clerk belongs to the store A, the register robot 2 may realize the function corresponding to the store A, and in a case where the store clerk belongs to the store B, the register robot 2 may realize the function corresponding to the store B. The register robot 2 is configured to change a device used to acquire the product information, thereby making it possible to acquire the product information by means appropriate for the product that belongs to the store. The register robot 2 may handle register operations for a plurality of stores, thereby allowing a smaller number of registers than that in a case where a register is installed in each of plurality of stores.

In addition, the register robot 2 is capable of preventing the product that does not belong to the store at which the register robot 2 is used, from being processed. In particular, in a case where the store clerk who is not familiar with the processing of the product in the store uses the register robot 2, it is effective to give notice of the product that does not belong to the store.

### 3: Third Example Embodiment

Next, an information processing apparatus, an information processing system, an information processing method, and a recording medium according to a third example embodiment will be described. The following describes the information processing apparatus, the information processing system, the information processing method, and the recording medium according to the third example embodiment, by using a register robot 3 to which the following describes the information processing apparatus, the information processing system, the information processing method, and the recording medium according to the third example embodiment are applied.

### [3-1: Configuration of Register Robot 3]

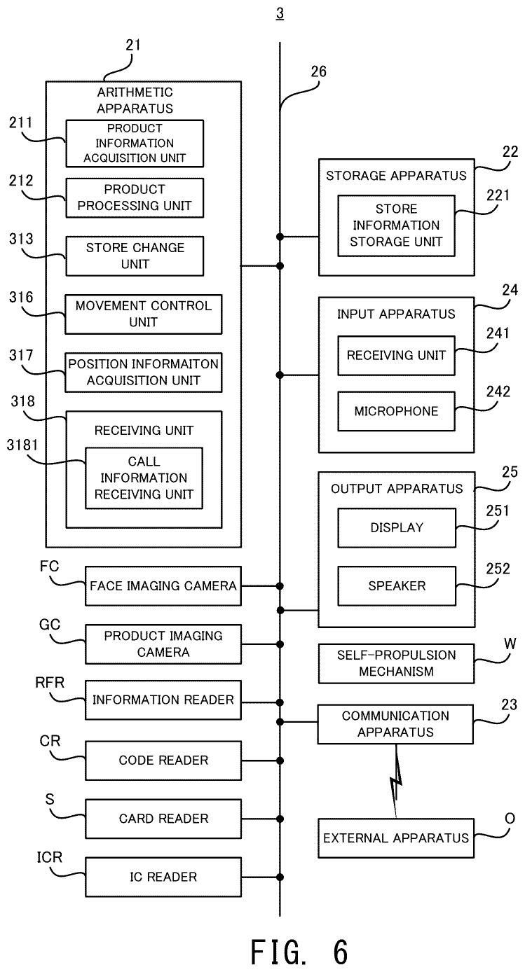

As illustrated in FIG. 6, the register robot 3 in the third example embodiment is provided with the arithmetic apparatus 21 and the storage apparatus 22, as in the register robot 2 in the second example embodiment. Furthermore, the register robot 3 in the third example embodiment may be provided with the communication apparatus 23, the input apparatus 24, and the output apparatus 25, as in the register robot 2 in the second example embodiment. The register robot 3, however, may not be provided with one of the input apparatus 24 and the output apparatus 25. The register robot 3 in the third example embodiment further includes a self-propulsion mechanism W that is a specific example of the “self-propulsion mechanism” described in Supplementary Notes later. As illustrated in FIG. 2, the register robot 3 may include, for example, wheels that are a part of the self-propulsion mechanism W. The self-propulsion mechanism W may be a mechanism suitable for moving on a plane. The self-propulsion mechanism W may include one or more wheels. The self-propulsion mechanism W may include a belt conveyor.

The register robot 3 differs from the register robot 2 in the second example embodiment, in that a movement control unit 316 that is a specific example of the “movement control unit” described in Supplementary Notes later, a position information acquisition unit 317 that is a specific example of the “position information acquisition unit” described in Supplementary Notes later, and a receiving unit 318 that is a specific example of the “receiving unit” described in Supplementary Notes later are realized in the arithmetic apparatus 21. The receiving unit 318 may include a call information receiving unit 3181.

In addition, the communication apparatus 23 provided in the register robot 3 in the third example embodiment may be configured to communicate with an external apparatus O that is an apparatus external to the register robot 3. The external apparatus O may be a terminal device carried by a store clerk. Other features of the register robot 3 in the third example embodiment may be the same as those of the register robot 2 in the second example embodiment. For this reason, a part differing from each of the example embodiments described above will be described in detail below, and a description of the other overlapping parts will be omitted as appropriate.

### [3-2: Information Processing Operation Performed by Register Robot 3]

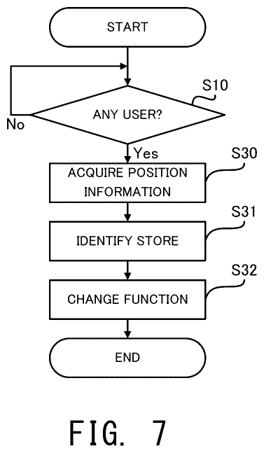

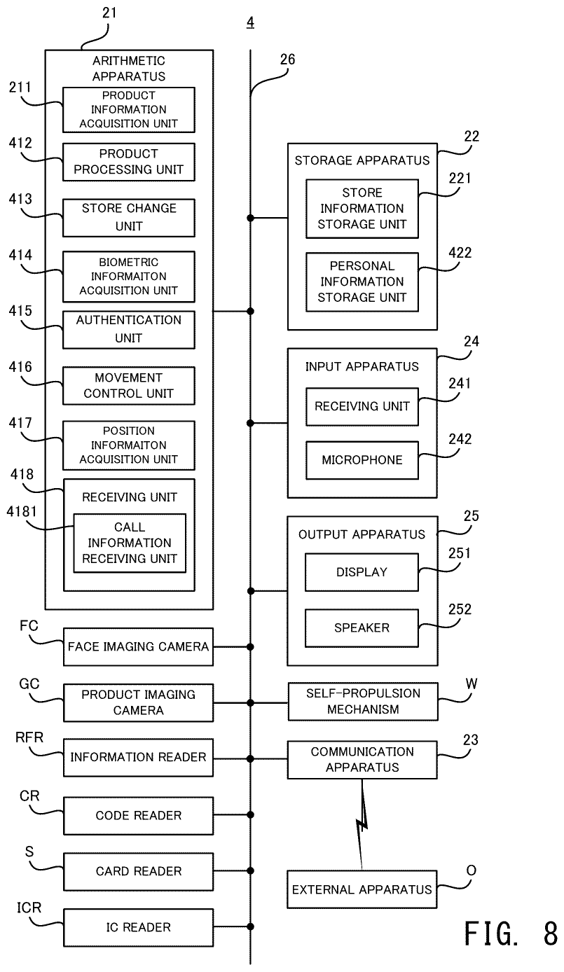

With reference to FIG. 7, a flow of the information processing operation performed by the register robot 3 will be described. The information processing operation performed by the register robot 3 differs from the information processing operation performed by the register robot 2, in a method of identifying a store at which the register robot 3 is used, in the store change operation. FIG. 7 is a flowchart illustrating the store change operation performed by the register robot 3. The payment operation performed by the register robot 3 may be the same as the payment operation performed by the register robot 2.

As illustrated in FIG. 7, a store change unit 313 determines whether or not there is a target who uses the register robot 3 (step S10). When there is a target that uses register robot 3 (step S10: Yes), the position information acquisition unit 317 acquires position information indicating a position of the register robot 3 (step S30). The position information acquisition unit 317 may, for example, acquire the position information by using a global positioning system. The store change unit 313 identifies the store at which the register robot 3 is used, based on the position information (step S31). The store information storage unit 221 may include area information indicating an area in which each store is located. The store change unit 313 may identify the store from the area including the position indicated by the position information. The store change unit 313 changes the function of at least one of the product information acquisition unit 211 and the product processing unit 212, depending on the identified store (step S32). After the store change unit 313 changes the function of at least one of the product information acquisition unit 211 and the product processing unit 212 depending on the identified store, the product processing unit 212 may determine the processing desired by the target and may perform the processing desired by the target, as in the second example embodiment.

The target who uses the register robot 3 in the third example embodiment, may be a purchaser. That is, the register robot 3 may function as a so-called self-checkout register. In this case, the processing performed by the product processing unit 212 may be only the payment processing. The product processing unit 212 may cause the display 251 to display a screen that allows the purchaser to select which payment method is used for the payment.

The register robot 3 in the third example embodiment, is configured to move to a location of the target, in response to a call from the target who needs the register robot 3. In this case, the target may be a store clerk. The call information receiving unit 3181 receives caller position information indicating a position of the target calling the register robot 3, and the movement control unit 316 controls the self-propulsion mechanism W that allows the register robot 3 to self-propel in response to the caller position information. In this case, the position information acquired by the position information acquisition unit 317 may be the caller position information, and the store change unit 313 may identify the store in response to the caller position information.

### [3-3: Technical Effect of Register Robot 3]

Since the register robot 3 in the third example embodiment is configured to identify the store at which the register robot 3 is used, based on a position at which the register robot 3 is used, it is possible to appropriately change the function of at least one of acquiring the product information and processing the product, depending on the store. The register robot 3 is configured to change a device used to acquire the product information, thereby making it possible to acquire the product information by means appropriate for the product that belongs to the store.

In addition, the register robot 3 is allowed to move to a position of the store clerk who needs the register robot 3, which improves convenience for the store clerk.

Furthermore, the register robot 3 is capable of preventing the product that does not belong to the store at which the register robot 3 is used, from being processed. For example, in a case where the register robot 3 is used as a so-called self-checkout register, it is effective to give notice of the product that does not belong to the store.

### 4: Fourth Example Embodiment

Next, an information processing apparatus, an information processing system, an information processing method, and a recording medium according to a fourth example embodiment will be described. The following describes the information processing apparatus, the information processing system, the information processing method, and the recording medium according to the fourth example embodiment, by using a register robot 4 to which the following describes the information processing apparatus, the information processing system, the information processing method, and the recording medium according to the fourth example embodiment are applied.

As illustrated in FIG. 8, the register robot 4 to which the fourth example embodiment is applied, may have both a function using the biometric information to identify a store and a function using the position information to identify a store. That is, it is possible to perform both the identification of a store by authentication of a store clerk and the identification of a store by a position at which the register robot 4 is used. In addition, a personal information storage unit 422 may be provided in the storage apparatus 22 of the register robot 4. The personal information storage unit 422 stores therein personal information on a purchaser, and the personal information may include biometric information on the purchaser and personal payment information. The personal payment information may be bank account information, credit card information, electronic money information, and the like.

### [4-1: Information Processing Operation Performed by Register Robot 4]

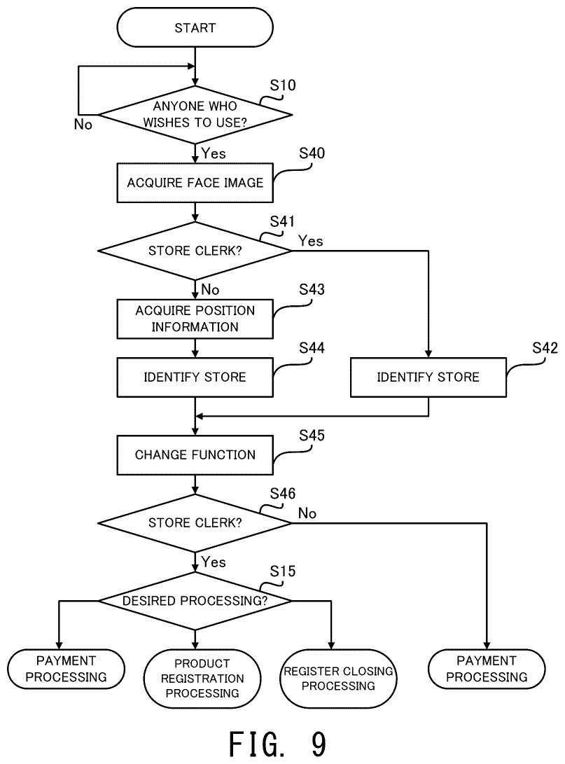

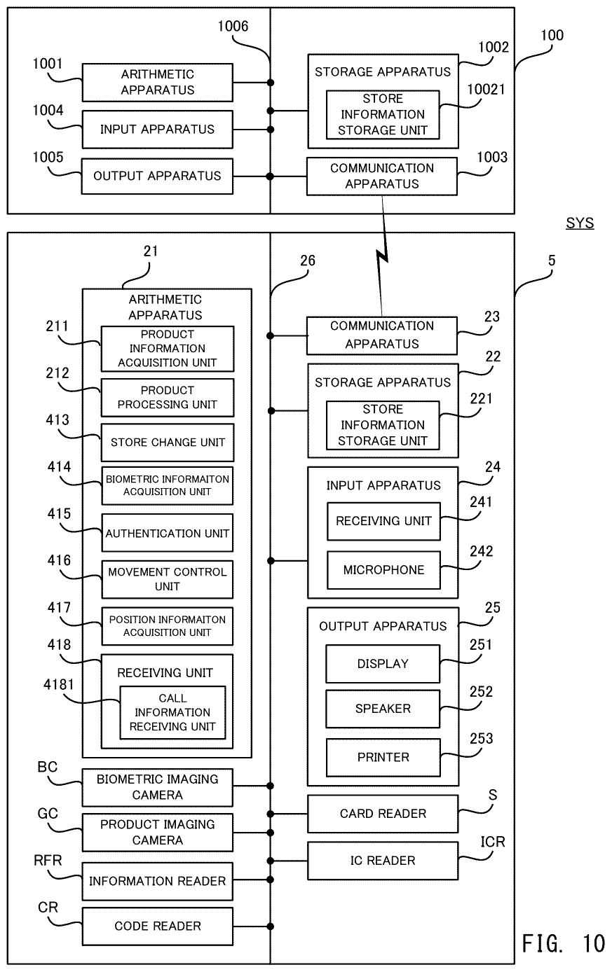

With reference to FIG. 9, a flow of the information processing operation performed by the register robot 4 will be described. The information processing operation performed by the register robot 4 differs in the store change operation from the information processing operation performed by the register robot 2 and the register robot 3. FIG. 9 is a flowchart illustrating the store change operation performed by the register robot 4.

As illustrated in FIG. 9, a store change unit 413 determines whether or not there is a target who uses the register robot 4 (step S10). When there is a target that uses register robot 4 (step S10: Yes), a biometric information acquisition unit 414 acquires the biometric information on the target (step S40).

An authentication unit 415 authenticates the target by using the biometric information and determines whether or not the target is a store clerk (step S41). When the target is a store clerk (step S41: Yes), the store change unit 413 identifies the store to which the store clerk belongs (step S42).

When the target is not a store clerk (step S41: No), a position information acquisition unit 417 acquires the position information (step S43). The store change unit 413 identifies the store, based on the position information (step S44). The store change unit 413 changes the function of at least one of the product information acquisition unit 211 and a product processing unit 412, depending on the store (step S45).

Using a determination result in the step S40, when the target is a store clerk (step S46: Yes), the desired processing is determined (step S15). That is, in a case where the store can be identified from the biometric information, the store clerk is using the register robot 4, and it may therefore function as a so-called manned register. For example, even if the position information does not indicate a position of the store, the register robot 4 may function as a register of the store identified from the biometric information.

When the target is not a store clerk (step S46: No), the product processing unit 412 performs the payment processing. That is, in a case where the store cannot be identified from the biometric information, the store may be identified based on the position information, and the register robot 4 may function as a so-called self-checkout register.

Furthermore, in a case where the target is not a store clerk, but is a registered purchaser, the authentication unit 415 may identify the target who is not a store clerk. In a case where the target is a purchaser registered in the personal information storage unit 422, the product processing unit 412 may perform the payment processing by using the registered personal payment information. For example, in a case where the bank account information is registered as the personal payment information, the product processing unit 412 may perform the payment processing directly from the account. Alternatively, in a case where the credit card information is registered as the personal payment information, the product processing unit 412 may perform the payment processing using the credit card.

Additionally, the product processing unit 412 may verify identity of the purchaser. For example, the product processing unit 412 may cause the display 251 to display a question “Are you N (the purchaser's name)?” and options “Yes” and “No,” and when the receiving unit 241 receives the purchaser's selection of “Yes,” the payment may be processed.

The store change unit 413 may change the function of at least one of the product information acquisition unit 211 and the product processing unit 412 such that the register robot 4 functions as a so-called manned register in a case where the store is identified by the store clerk, and such that the register robot 4 functions as a so-called self-checkout register in a case where the store cannot be identified by the store clerk, but is identified based on the position information.

### [4-2: Technical Effect of Register Robot 4]

In the register robot 4 in the fourth example embodiment, functioning as a so-called manned register and functioning as a so-called self-checkout register may be changed depending on the target.

### 5: Fifth Example Embodiment

Next, an information processing apparatus, an information processing system, an information processing method, and a recording medium according to a fifth example embodiment will be described. The following describes the information processing apparatus, the information processing system, the information processing method, and the recording medium according to the fifth example embodiment, by using an information processing system SYS to which the following describes the information processing apparatus, the information processing system, the information processing method, and the recording medium according to the fifth example embodiment are applied.

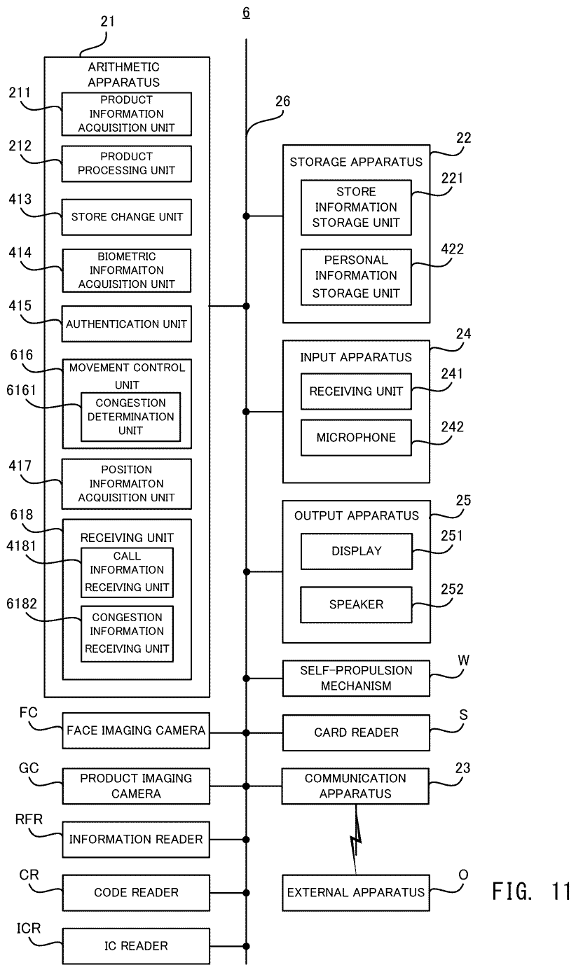

FIG. 10 is a block diagram illustrating a configuration of the information processing system SYS in the fifth example embodiment. As illustrated in FIG. 10, the information processing system SYS in the fifth example embodiment includes a register robot 5 that is a specific example of the “payment support apparatus” described in Supplementary Notes later, and a shared apparatus 100 that is a specific example of the “shared apparatus” described in Supplementary Note later. The information processing system SYS may include a plurality of register robots 5.

As illustrated in FIG. 10, the shared apparatus 100 is provided with an arithmetic apparatus 1001, a storage apparatus 1002, and a communication apparatus 1003. Furthermore, the shared apparatus 100 may be provided with an input apparatus 1004 and an output apparatus 1005. The shared apparatus 100, however, may not be provided with at least one of the input apparatus 1004 and the output apparatus 1005. The arithmetic apparatus 1001, the storage apparatus 1002, the communication apparatus 1003, the input apparatus 1004, and the output apparatus 1005 may be connected via a data bus 1006.

The arithmetic apparatus 1001, as in the arithmetic apparatus 21, includes, for example, at least one of a CPU (Central Processing Unit), a GPU (Graphics Processing Unit), and a FPGA (Field Programmable Gate Array). The arithmetic apparatus 1001 reads a computer program. For example, the arithmetic apparatus 1001 may read a computer program stored in a computer-readable and non-transitory recording medium, by using a not-illustrated recording medium reading apparatus provided in the shared apparatus 100 (e.g., the input apparatus 1004 described later). The arithmetic apparatus 1001 may acquire (i.e., download or read) a computer program from a not-illustrated apparatus disposed outside the shared apparatus 100, via the communication apparatus 1003 (or another communication apparatus). The arithmetic apparatus 1001 executes the read computer program. Consequently, a logical function block for performing an operation to be performed by the shared apparatus 100 is realized in the arithmetic apparatus 1001. That is, the arithmetic apparatus 1001 is allowed to function as a controller for realizing the logical function block for performing an operation (in other words, processing) to be performed by the shared apparatus 100.

The storage apparatus 1002, as in the storage apparatus 22, is configured to store desired data. For example, the storage apparatus 1002 may temporarily store a computer program to be executed by the arithmetic apparatus 1001. The storage apparatus 1002 may temporarily store data that are temporarily used by the arithmetic apparatus 1001 when the arithmetic apparatus 1001 executes the computer program. The storage apparatus 1002 may store data that are stored for a long time by the shared apparatus 100. The storage apparatus 1002 may include at least one of a RAM (Random Access Memory), a ROM (Read Only Memory), a hard disk apparatus, a magneto-optical disk apparatus, a SSD (Solid State Drive), and a disk array apparatus. That is, the storage apparatus 1002 may include a non-transitory recording medium.

A store information storage unit 10021 may be realized in the storage apparatus 1002. The store information storage unit 10021 stores therein information on the register robot 5 including: at least one of position information indicating a position of the register robots 5; usage status information indicating a usage status of the register robots 5; and payment information indicating payment at the register robots 5, which are acquired from each of the plural register robots 5 via the communication apparatus 23 and the communication apparatus 1003. The usage status information indicating the usage status of the register robot 5 may include congestion information indicating a degree of congestion around the register robot 5. In the store information storage unit 10021, information registered in the store information storage unit 221 of each of the plurality of register robots 5 may also be registered.

The communication apparatus 1003 is configured to communicate with an apparatus external to the shared apparatus 100 via a not-illustrated communication network. The communication apparatus 1003 may be a communication interface based on standards such as Ethernet (registered trademark), Wi-Fi (registered trademark), Bluetooth (registered trademark), and USB (Universal Serial Bus). The shared apparatus 100 transmits information to and receives information from the register robot 5 via the communication apparatus 1003.

The input apparatus 1004 is an apparatus that receives an input of information to the shared apparatus 100 from an outside of the shared apparatus 100. The output apparatus 1005 is also an apparatus that outputs information to the outside of the shared apparatus 100.

In the present example embodiment, any one of the functions realized in the arithmetic apparatus 21 provided in the register robot 5 may be realized in the arithmetic apparatus 1001 of the shared apparatus 100. The register robot 5 may realize any one of the functions realized in the arithmetic apparatus 21, by control of the shared apparatus 100. For example, in the register robot 5, the self-propulsion mechanism W may be driven by the control of the shared apparatus 100.

### [Technical Effect of Information Processing System SYS]

In the fifth example embodiment, the shared apparatus 100 acquires and records information from each of the plurality of register robots 5. This allows, for example, each register robot 5 to move to a location where it needs to go. In addition, even when the plurality of register robots 5 are used in the same store, the store easily handles an accurate payment amount for the store.

### 6: Sixth Example Embodiment

Next, an information processing apparatus, an information processing system, an information processing method, and a recording medium according to a sixth example embodiment will be described. The following describes the information processing apparatus, the information processing system, the information processing method, and the recording medium according to the sixth example embodiment, by using a register robot 6 to which the following describes the information processing apparatus, the information processing system, the information processing method, and the recording medium according to the sixth example embodiment are applied.

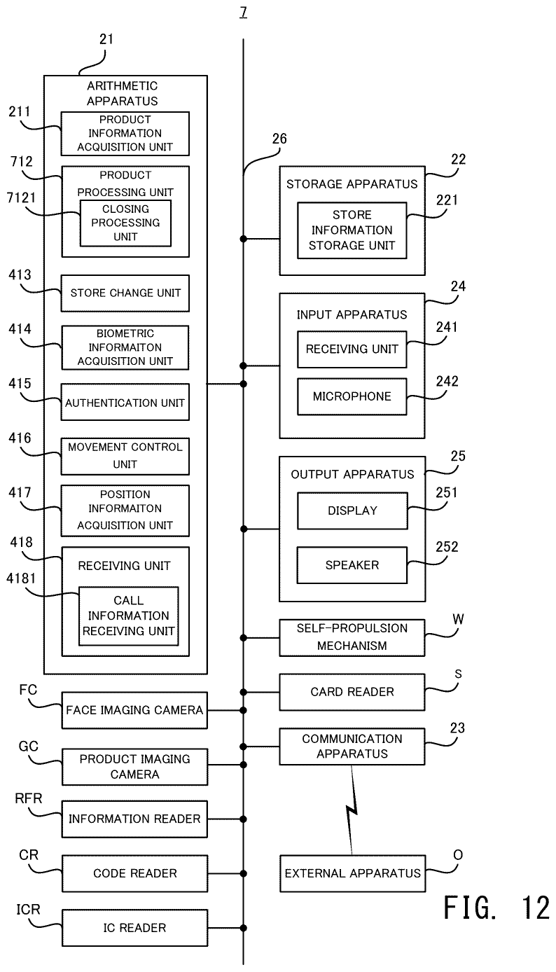

As illustrated in FIG. 11, the register robot 6 to which the sixth example embodiment is applied, differs from the register robot 2 in the second example embodiment to the register robot 5 in the fifth example embodiment, in that a movement control unit 616 further includes a congestion determination unit 6161 and a receiving unit 618 further includes a congestion information receiving unit 6182.

### [6-1: Information Processing Operation Performed by Register Robot 6]

The congestion information receiving unit 6182 receives congestion information indicating a degree of congestion around the external apparatus O, from the external apparatus O external to the register robot 6. The external apparatus O may be another register robot 6, or an apparatus similar to the shared apparatus 100 described in the fifth example embodiment (referred to as a “shared apparatus”).

The congestion information receiving unit 6182 may receive congestion information indicating a degree of congestion at a store at which another register robot 6 is used, from the other register robot 6. The congestion information receiving unit 6182 may acquire an image of the store at which the other register robot 6 is used, as the congestion information, from the other register robot 6.

The shared apparatus may manage a monitoring/surveillance camera. The congestion information receiving unit 6182 may acquire an image captured by the monitoring camera, as the congestion information, from the shared apparatus.

In addition, the congestion information receiving unit 6182 may acquire usage status information indicating a usage status of the register robot 6 in an area in which the register robot 6 is movable, from the shared apparatus. The congestion determination unit 6161 may determine the degree of congestion based on the usage status information.

The congestion determination unit 6161 controls the self-propulsion mechanism W based on the congestion information. The congestion determination unit 6161 may determine a store with a relatively high degree of congestion, by using the congestion information. The congestion determination unit 6161 may control the self-propulsion mechanism W to move to the store with a relatively high degree of congestion.

Alternatively, a store clerk at a congested store may call the register robot 6. In this case, the call information receiving unit 4181 receives caller position information indicating a position of the store clerk calling the register robot 6, from a terminal device carried by the store clerk at the congested store, and may move the register robot 6 to the store to which the store clerk belongs.

Furthermore, the register robot 6 may request another register robot 6 for help, depending on its own usage status.

### [6-2: Technical Effect of Register Robot 6]

Since the register robot 6 in the sixth example embodiment is allowed to move to a crowded location, it is possible to appropriately support the store, without making the target who wishes to use the register robot 6 wait.

### 7: Seventh Example Embodiment

Next, an information processing apparatus, an information processing system, an information processing method, and a recording medium according to a seventh example embodiment will be described. The following describes the information processing apparatus, the information processing system, the information processing method, and the recording medium according to the seventh example embodiment, by using a register robot 7 to which the following describes the information processing apparatus, the information processing system, the information processing method, and the recording medium according to the seventh example embodiment are applied.

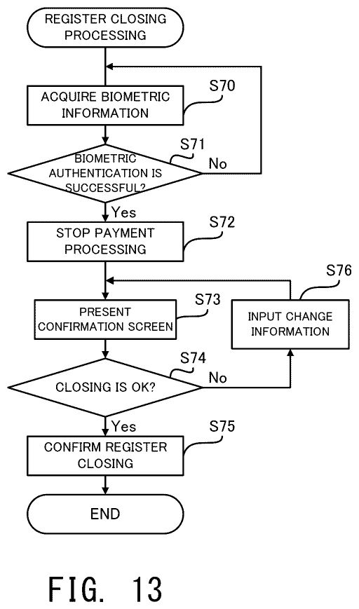

As illustrated in FIG. 12, the register robot 7 to which the seventh example embodiment is applied, differs from the register robot 2 to the register robot 6, in that a product processing unit 712 includes a closing processing unit 7121. The register closing processing performed by the closing processing unit 7121 may be summarizing and confirming the payment amount settled on that day.

### [7-1: Information Processing Operation Performed by Register Robot 7]

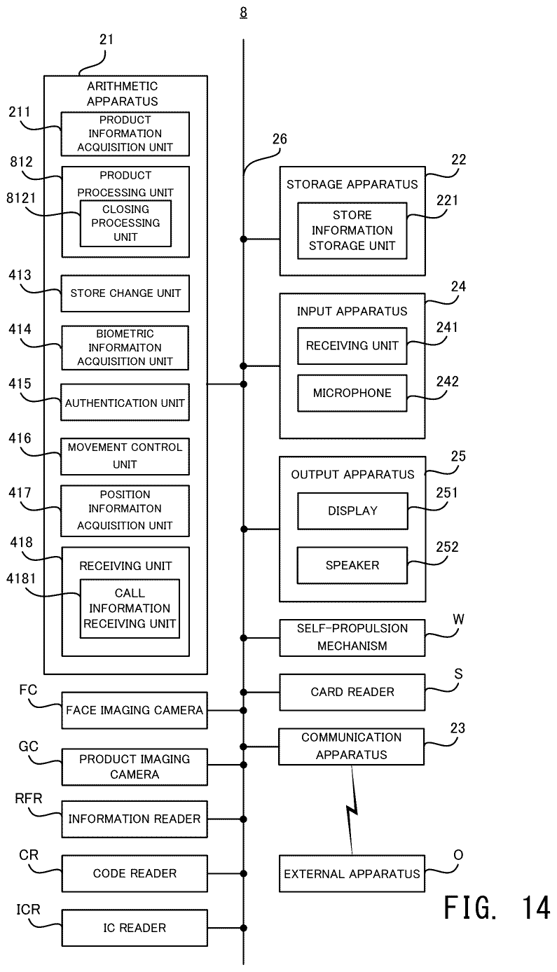

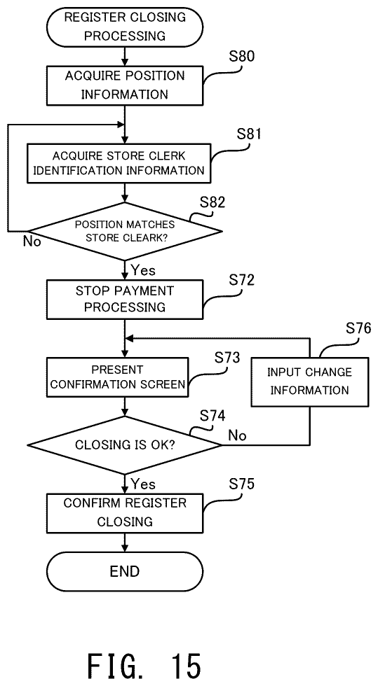

With reference to FIG. 13, a flow of the information processing operation performed by the register robot 7 will be described. FIG. 13 is a flowchart illustrating the register closing processing performed by the register robot 7.

In a case where an instruction of the closing processing of the payment processing at a store is received from the target, as illustrated in FIG. 13, the closing processing unit 7121 causes the biometric information acquisition unit 414 to acquire the biometric information on the store clerk (step S70). The closing processing unit 7121 determines whether the authentication of the store clerk using the biometric information by the authentication unit 415 is successful (step S71).

When the authentication of the store clerk using the biometric information by the authentication unit 415 is successful (step S71: Yes), the closing processing unit 7121 stops the payment processing by the product processing unit 712 (step S72). The closing processing unit 7121 may determine whether the authenticated store clerk is a store clerk who is permitted to perform the register closing processing. In a case where the store clerk is permitted to perform the cash register closing processing, the closing processing unit 7121 may stop the payment processing for the relevant store by the register robot 7.

The closing processing unit 7121 presents confirmation information (step S73). The closing processing unit 7121 may, for example, cause the display 251 to display information on transactions settled on a given day registered in the settlement table. The closing processing unit 7121 may, for example, present a total amount for each payment method. The closing processing unit 7121 determines whether or not there is an input of information from the store clerk indicating that it is permissible to close the register (step S74). When it is permissible to close the register (step S74, Yes), the closing processing unit 7121 finalizes the register closing processing (step S75). For example, for cash payment and direct transfer transaction from the account, a request for transfer to the store's account may be made. Alternatively, the register robot 7 may be configured dispense cash when the store so desires.

When there are a plurality of register robots 7, as described in the fifth example embodiment, the payments/settlements by the plurality of register robots 7 aggregated by the shared apparatus 100 may be summarized to perform the register closing operation. In addition, in the steps S13, S31, S42, and S44 described above, when the identified store is a store at which the register closing processing is already performed, the product processing unit may issue an alert notification.

### [7-2: Technical Effect of Register Robot 7]

The register robot 7 in the seventh example embodiment is allowed to appropriately perform the register closing processing, in response to an instruction from the store clerk who belongs to the store.

### 8: Eighth Example Embodiment

Next, an information processing apparatus, an information processing system, an information processing method, and a recording medium according to an eighth example embodiment will be described. The following describes the information processing apparatus, the information processing system, the information processing method, and the recording medium according to the eighth example embodiment, by using a register robot 8 to which the following describes the information processing apparatus, the information processing system, the information processing method, and the recording medium according to the eighth example embodiment are applied.

The register robot 8 to which the eighth example embodiment is applied, differs in a method of authenticating the target, from the register robot 7 to which the seventh example embodiment is applied. The information processing operation performed by the register robot 8 may be an operation that can be performed by a store clerk who possesses particular identification information.

### [8-1: Information Processing Operation Performed by Register Robot 8]

With reference to FIG. 15, a flow of the information processing operation performed by the register robot 8 will be described. FIG. 15 is a flowchart illustrating the register closing processing performed by the register robot 8.

In a case where an instruction of the closing processing of the payment processing at a store is received from the target, as illustrated in FIG. 15, a closing processing unit 8121 causes the position information acquisition unit 417 to acquire position information indicating a position of the register robot 8 (step S80). The closing processing unit 8121 causes the store change unit 413 to identify a store at which the register robot 8 is used, based on the position information (step S81). The closing processing unit 8121 acquires, from the store clerk, identification information capable of identifying the store clerk, and determines whether or not the store clerk is a person who belongs to the store by using the identification information (step S82). The closing processing unit 8121 may acquire the identification information on the store clerk, for example, by having the store clerk present his or her employee ID card. The identification information capable of identifying the store clerk may be the biometric information on the store clerk. When the store clerk is a person who belongs to the store (step S82: Yes), the steps S72 to S76 described with reference to FIG. 13 are performed.

### [8-2: Technical Effect of Register Robot 8]

The register robot 8 is allowed to appropriately perform the register closing processing, in response to an instruction from the store clerk who belongs to the store.

### 9: Supplementary Notes

With respect to the example embodiments described above, the following Supplementary Notes are further disclosed.

### Supplementary Note 1

An information processing apparatus including:
a product information acquisition unit that acquires product information about a product;
a product processing unit that processes the product by using the product information; and
a change unit that changes an operation of at least one of the product information acquisition unit and the product processing unit, depending on at least one of a target who uses the information processing apparatus and a position of the information processing apparatus.

### Supplementary Note 2

The information processing apparatus according to Supplementary Note 1, further including:
a biometric information acquisition unit that acquires biometric information on the target; and
a biometric authentication unit that authenticates the target by using the biometric information, wherein
the change unit identifies a store to which the target who uses the information processing apparatus belongs, based on a result of authentication by the biometric authentication unit, and changes the operation of at least one of the product information acquisition unit and the product processing unit.

### Supplementary Note 3

The information processing apparatus according to Supplementary Note 2, wherein the change unit changes the operation of at least one of the product information acquisition unit and the product processing unit to perform an operation related to a first store in a case where a target who belongs to the first store is authenticated, and changes the operation of at least one of the product information acquisition unit and the product processing unit to perform an operation related to a second store in a case where a target who belongs to the second store is authenticated.

### Supplementary Note 4

The information processing apparatus according to Supplementary Note 1, further including:
a movement control unit that controls a self-propulsion mechanism that allows the information processing apparatus to self-propel; and
a position information acquisition unit that acquires position information indicating the position of the information processing apparatus, wherein
the change unit identifies a store at which the information processing apparatus is used, based on the position information, and changes the operation of at least one of the product information acquisition unit and the product processing unit.

### Supplementary Note 5

The information processing apparatus according to Supplementary Note 4, further including:
a call information receiving unit that receives caller position information indicating a position of a target calling the information processing apparatus, wherein
the movement control unit controls the self-propulsion mechanism, based on the caller position information.

### Supplementary Note 6

The information processing apparatus according to Supplementary Note 4, further including:
a congestion information receiving unit that receives, from an external apparatus of the information processing apparatus, congestion information indicating a degree of congestion around the external apparatus, wherein
the movement control unit controls the self-propulsion mechanism, based on the congestion information.

### Supplementary Note 7

The information processing apparatus according to Supplementary Note 2 or 3, wherein
the product information acquisition unit is configured to acquire the product information from a device including at least one of:
   an imaging device that captures images of the product;
   a code reader that reads a code obtained by encoding the product information about the product attached to the product;
   an information reader that reads the product information about the product attached to the product; and
   a receiving device that detects an instruction action of the target and receives an input corresponding to the product, and
the change unit identifies a store at which the information processing apparatus is used, and changes from which device of the device the product information acquisition unit acquires the product information.

### Supplementary Note 8

The information processing apparatus according to Supplementary Note 2 or 3, wherein
the change unit identifies at which store the information processing apparatus is used, and
in response to acquisition of product information indicating a product that does not belong to a store at which the information processing apparatus is used, the product information acquisition unit outputs information indicating the product that does not belong to the store.

### Supplementary Note 9

The information processing apparatus according to Supplementary Note 2, wherein
the product processing unit,
   in response to an instruction of closing processing of payment processing at the store being received from the target,
   causes the biometric information acquisition unit to acquire the biometric information on the target, and
   causes the biometric authentication unit to authenticate the target by using the biometric information, and
   performs the closing processing in response to a success in authentication by the biometric authentication unit.

### Supplementary Note 10

The information processing apparatus according to Supplementary Note 4, wherein
the product processing unit,
   in response to an instruction of closing processing of payment processing at the store being received from the target,
   causes the position information acquisition unit to acquire the position information indicating the position of the information processing apparatus,
   causes the change unit to identify a store at which the information processing apparatus is used, based on the position information,
   acquires, from the target, identification information capable of identifying the target, and
   performs the closing processing in a case where the target is a person who belongs to the store, by using the identification information.

### Supplementary Note 11

An information processing system including:
a plurality of payment support apparatuses; and
a shared apparatus,
each of the plurality of payment support apparatuses including:
a product information acquisition unit that acquires product information indicating a product;
a product processing unit that processes the product by using the product information;
a change unit that changes an operation of at least one of the product information acquisition unit and the product processing unit, depending on at least one of a target who uses the payment support apparatus and a position of the payment support apparatus; and
a payment communication unit that communicates with an external apparatus of the payment support apparatus,
the shared apparatus including:
a shared communication unit that communicates with an external apparatus of the shared apparatus; and
a recording unit that acquires, from each of the plurality of payment support apparatuses via the payment communication unit and the shared communication unit, payment support apparatus information including at least one of position information indicating a position of the payment support apparatus, usage status information indicating a usage status of the payment support apparatus, and payment information indicating payment made at the payment support apparatus, the recording unit recording the payment support apparatus information.

### Supplementary Note 12

An information processing method including:
acquiring product information about a product, by using a product information acquisition unit that provided in an information processing apparatus;
processing the product by using the product information, by using a product processing unit that provided in the information processing apparatus; and
changing an operation of at least one of the product information acquisition unit and the product processing unit, depending on at least one of a target who uses the information processing apparatus and a position of the information processing apparatus.

### Supplementary Note 13

A recording medium on which a computer program that allows a computer to execute an information processing method is recorded, the information processing method including:
acquiring product information about a product, by using a product information acquisition unit that provided in an information processing apparatus;
processing the product by using the product information, by using a product processing unit that provided in the information processing apparatus; and
changing an operation of at least one of the product information acquisition unit and the product processing unit, depending on at least one of a target who uses the information processing apparatus and a position of the information processing apparatus.

The present disclosure is allowed to be changed, if desired, without departing from the essence or spirit of this disclosure which can be read from the claims and the entire specification. An information processing apparatus, an information processing system, an information processing method, and a recording medium with such changes are also intended to be within the technical scope of the present disclosure.

### DESCRIPTION OF REFERENCE CODES

1 Information processing apparatus
11, 211 Product information acquisition unit
12, 212, 412, 712, 812 Product processing unit
13, 213, 313, 413 Store change unit
2, 3, 4, 5, 6, 7, 8 Register robot
214, 414 Biometric information acquisition unit
215, 415 Authentication unit
221, 10021 Store information storage unit
241 Receiving unit
242 Microphone
251 Display
252 Speaker
253 Printer
BC Biometric imaging camera
GC Product imaging camera
RFR Information reader
CR Code reader
S Card reader
ICR IC reader
316, 416, 616 Movement control unit
317, 417 Position information acquisition unit
318, 418, 518, 618 Receiving unit
3181, 4181 Call information receiving unit
W Self-propulsion mechanism
O External apparatus
422 Personal information storage unit
SYS Information processing system
100 Shared apparatus
6161 Congestion determination unit
6182 Congestion information receiving unit
7121, 8121 Closing processing unit

What is claimed is:

1. An information processing apparatus comprising:
at least one memory storing instructions; and
at least one processor that is configured to execute the instructions for:
acquiring product information about a product, by using a product information acquisition device;
processing the product by using the product information; and
changing an operation of at least one of the acquiring product information and the processing, depending on at least one of a target who uses the information processing apparatus and a position of the information processing apparatus.

2. The information processing apparatus according to claim 1, wherein the at least one processor is configured to execute the instructions for:
acquiring biometric information on the target;
authenticating the target by using the biometric information; and
identifying a store to which the target who uses the information processing apparatus belongs, based on a result of the authenticating, and changing the operation of at least one of the acquiring product information and the processing.

3. The information processing apparatus according to claim 2, wherein the at least one processor is configured to execute the instructions for changing the operation of at least one of the acquiring product information and the processing to perform an operation related to a first store in a case where a target who belongs to the first store is authenticated, and changing the operation of at least one of the acquiring product information and the processing to perform an operation related to a second store in a case where a target who belongs to the second store is authenticated.

4. The information processing apparatus according to claim 1, wherein the at least one processor is configured to execute the instructions for:
controlling a self-propulsion mechanism that allows the information processing apparatus to self-propel;
acquiring position information indicating the position of the information processing apparatus; and
identifying a store at which the information processing apparatus is used, based on the position information, and changing the operation of at least one of the acquiring product information and the processing.

5. The information processing apparatus according to claim 4, wherein the at least one processor is configured to execute the instructions for:
receiving caller position information indicating a position of a target calling the information processing apparatus;
controlling the self-propulsion mechanism, based on the caller position information.

6. The information processing apparatus according to claim 4, wherein the at least one processor is configured to execute the instructions for:
receiving, from an external apparatus of the information processing apparatus, congestion information indicating a degree of congestion around the external apparatus;
controlling the self-propulsion mechanism, based on the congestion information.

7. The information processing apparatus according to claim 2, wherein
the product information acquisition device includes at least one of:
an imaging device that captures images of the product;
a code reader that reads a code obtained by encoding the product information about the product attached to the product;
an information reader that reads the product information about the product attached to the product; and
a receiving device that detects an instruction action of the target and receives an input corresponding to the product, and
the at least one processor is configured to execute the instructions for identifying a store at which the information processing apparatus is used, and changing from which device included in the product information acquisition device to acquire the product information.

8. The information processing apparatus according to claim 2, wherein the at least one processor is configured to execute the instructions for:
identifying at which store the information processing apparatus is used; and
in response to acquisition of product information indicating a product that does not belong to a store at which the information processing apparatus is used, outputting information indicating the product that does not belong to the store.

9. The information processing apparatus according to claim 2, wherein the at least one processor is configured to execute the instructions for:
in response to an instruction of closing processing of payment processing at the store being received from the target,
acquiring the biometric information on the target;
authenticating the target by using the biometric information;
performing the closing processing in response to a success in the authenticating.

10. The information processing apparatus according to claim 4, wherein the at least one processor is configured to execute the instructions for:
in response to an instruction of closing processing of payment processing at the store being received from the target,
acquiring the position information indicating the position of the information processing apparatus;
identifying a store at which the information processing apparatus is used, based on the position information;
acquiring, from the target, identification information capable of identifying the target; and
performing the closing processing in a case where the target is a person who belongs to the store, by using the identification information.

11. An information processing system comprising:
a plurality of payment support apparatuses; and
a shared apparatus,
each of the plurality of payment support apparatuses including:
a payment communication device that communicates with an external apparatus of the payment support apparatus;
at least one memory storing instructions; and
at least one processor that is configured to execute the instructions for:
acquiring product information about a product, by using a product information acquisition device;
processing the product by using the product information; and
changing an operation of at least one of the acquiring product information and the processing, depending on at least one of a target who uses the information processing apparatus and a position of the information processing apparatus,
the shared apparatus including:
a shared communication device that communicates with an external apparatus of the shared apparatus; and
at least one memory storing instructions; and
at least one processor that is configured to execute the instructions for
acquiring, from each of the plurality of payment support apparatuses via the payment communication device and the shared communication device, payment support apparatus information including at least one of position information indicating a position of the payment support apparatus, usage status information indicating a usage status of the payment support apparatus, and payment information indicating payment made at the payment support apparatus, and recording the payment support apparatus information.

12. An information processing method comprising:
acquiring product information about a product, by using a product information acquisition device that provided in an information processing apparatus;
processing the product by using the product information; and
changing an operation of at least one of the acquiring product information and the processing, depending on at least one of a target who uses the information processing apparatus and a position of the information processing apparatus.

13. (canceled)
